(19) United States
(12) Patent Application Publication
(10) Pub. No.: US 2004/0063353 A1
(43) Pub. Date: Apr. 1, 2004

(54) Solar panel adapter

(75) Inventor: Zoltan Egeresi, Santa Cruz, CA (US)

Correspondence Address: ZOLTAN EGERESI, 5500 COAST RD., SANTA CRUZ, CA, 95060, US

(73) Assignee: Zoltan Egeresi, Santa Cruz, CA

(21) Appl. No.: 10/254,292

(22) Filed: Sep. 26, 2002

(51) Int. Cl. H01R 3/00

(52) U.S. Cl. 439/500

(57) ABSTRACT

Few portable electronic devices have built in solar powered recharging device for providing additional charge for the portable units. This special SOLAR PANEL ADAPTER (for Camcorders, portable CD players, radios, cell phones) sandwiches between the spring loaded connector of the electronic apparatus and the rechargeable battery (FIG. 4B) It allows the user to keep the rechargeable battery connected while a solar panel charges the battery, extending the usage time. This is especially useful on longer trips, out in the open camping, hiking, walking where no recharging is available.

REFERENCES IN US PATENTS

| 6,084,379 | Buniatyan, Spartak July 2000 | |
|---|---|---|
| | Solar powered recharging device | |
| D364889 | Goldmaster Solar charged radio | |
| 5701067 | December 1997 | Kaji et al. |
| 5814906 | December 1996 | Spencer, Jerald |
| 4537838 | August 1985 | Jetter et al. |
| 4686441 | August 1987 | Petterson |
| 4786851 | November 1988 | Fuji et al. |
| 5133810 | July 1992 | Morizane et al. |
| 5253300 | October 1993 | Knapp |
| 5522943 | Junuary 1996 | Spencer et al. |
| International Patent references | | |
| 2040607 | Solar radio UK | |
| 9800429 | Solar radio, Hong Kong | |
| 3611544 | October 1987 | DE |
| 9405672 | August 1994 | DE |
| 61-123550 | August 1986 | IP. |
| 61-129436 | August 1986 | JP. |
| 4-218980 | August 1992 | JP. |

| | |
|---|---|
| Current U.S. Class: | 320/101; 320/114 |
| Intern'l Class: | H02J 007/35; H01M 010/46 |
| Field of Search: | 320/101,114 136/245,246 |

### DESCRIPTION OF PRIOR ARTS

U.S. Pat. No. 6,326,764 Dec. 4, 2001 This Solar-powered CD player and electrical generator invention is big, heavy, bulky definitively is not something you want to walk around with.

U.S. Pat. No. 6,084,379 Jul. 4 2000, Portable solar panel is attached to a recharging external cradle/rechargeable battery and not direct to the internal, or factory designed, supplied rechargeable battery. Connectivity is to communication device, cell phone, type of connection is rather vague, unexplained. Most cell phones have easily accessible 12V DC adapter plugs.

U.S. Pat. No. 5,814,906 Sep. 29, 1998 shows a mobile, detachable solar panel with common detachable connector. U.S. Pat. No. D364869 Everstep Dec. 5, 1995 is built in a solar battery powered radio.

U.S. Pat. No. 5,701,067 Kaji, et al. Sanyo, Dec. 23, 1997 Battery charger and solar cells for battery charging system.

There are other portable power systems designed for generating electricity. Typical of these is U.S. Pat. No. 4,827,534 issued to Alvin E. Haugen on May 9, 1989.

Another patent was issued to Steven E. Summer on May 29, 1990 as U.S. Pat. No. 4,929,873. Yet another U.S. Pat. No. 4,999,545 was issued to Steven E. Summer on Mar. 12, 1991 and another was issued on May 5, 1992 to Woodward Johnson, U.S. Pat. No. 5,111,127. Another patent was issued to John W. Seazholtz on Apr. 7, 1998 as U.S. Pat. No. 5,737,706,. U.S. Pat. No. 5,889,384 was issued to John J. Hayes et al. on Mar. 30, 1999. Another was issued to John Edward Pfeifer et al. on Jul. 27, 1999.

The use of battery chargers is known in the prior art.

Known prior art battery chargers include U.S. Pat. No. 4,441,143 to Richardson, Jr.; U.S. Pat. No. 4,786,851 to Fuji et al.; U.S. Pat. No. Des. 277,844 to Toews; U.S. Pat. No. 4,871,959 to Gali; U.S. Pat. No. 5,377,256 to Franklin et al.; and U.S. Pat. No. 4,905,270 to Ono.

### BACKGROUND OF THE INVENTION

This invention relates to portable small electronic equipments, solar battery charger and the solar cell connectivity to camcorder, CD player, portable radios, cell phones and other portable devices. All types of electrical equipment have been miniaturized and made lightweight, portable and they use throw away batteries or rechargeable ones using AC current on fixed location or 12VDC from cars. This adapter cable enables the portable electrical equipment to be charged on the go as the apparatus is being used, extending the working cycle of it. Many times, there is not enough time or convenient place to recharge the battery, or no spare battery is available, or during recharging time the electronic apparatus can not be used. My invention uses a special adapter, a flat cable adapter sandwiched between the spring loaded connectors of the electronic apparatus and the rechargeable battery. By using environment friendly renewable solar power (many prior art types available) to charge the batteries while it provides energy to the electronic apparatus, it extends battery life, the usage time of the electronic apparatus.

### BRIEF SUMMERY OF THE INVENTION

Few portable electronic devices have built in solar powered recharging device for providing additional charge for the portable units. Camcorder rechargeable batteries, digital cameras, cell phones have special molded bases where the design is such, that it frustrates any attempt for a solar panel connection, preventing battery charging while the battery is attached to the camcorder or any other portable apparatus. This special SOLAR PANEL ADAPTER allows the user to keep the battery connected while a solar panel charges the battery day time, extending the charge and usage time. This is especially useful on longer trips out in the open camping, hiking, walking where no recharging is available or carrying extra batteries is too heavy.

Many portable electronic devices like cell phones use electricity even in standby mode.

By providing a Velcro attached solar panel with a special SOLAR PANEL ADAPTER it can provide sufficient trickle charge to maintain operational voltage level while user is on the go, camping, tourist trips etc. The object of this invention is to adapt many currently available solar panels with a special SOLAR PANEL ADAPTER cable to cell phones, cam coders, CD players to extend battery life.

The manufacturers deliberately design battery connection in such a way, that only their special molded battery can be connected forcing end users to by only original, more expensive battery replacements.

### BRIEF DESCRIPTION OF THE DRAWING

The actual invention is shown on sheet 2 of 2 FIG. 4B perspective view of the adapter cable assembly, the other drawings explains the actual application as the invention.

FIG. 1 shows the bottom

FIG. 2 shows the side and end view of a flat rechargeable battery (1), of a camcorder or a cell phone where a flat, flexible conductor (2)is secured to the battery by means of two sided adhesive tape FIG. 3B (9) as it sandwiches between the rechargeable battery and the body of the camcorder or cell phone (8). Spring loaded electronic contact of the electronic apparatus (7) presses against a flat adapter cable and battery contact (5). Adapter cable is terminated with the DC plug (3) to be connected to a solar cell or other type of external power source.

FIG. 3 and FIG. 4 shows a flat battery (1) on the electronic apparatus (8) with the spring loaded connector (7) pressing against flat adapter cable (2) at un-insulated contact location (6).

### DETAILED DESCRIPTION OF THE DRAWING

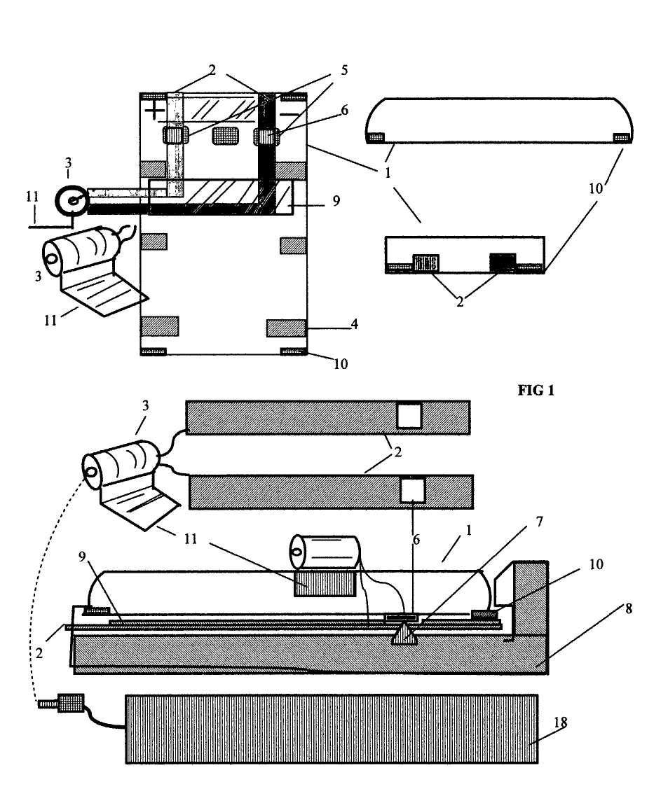

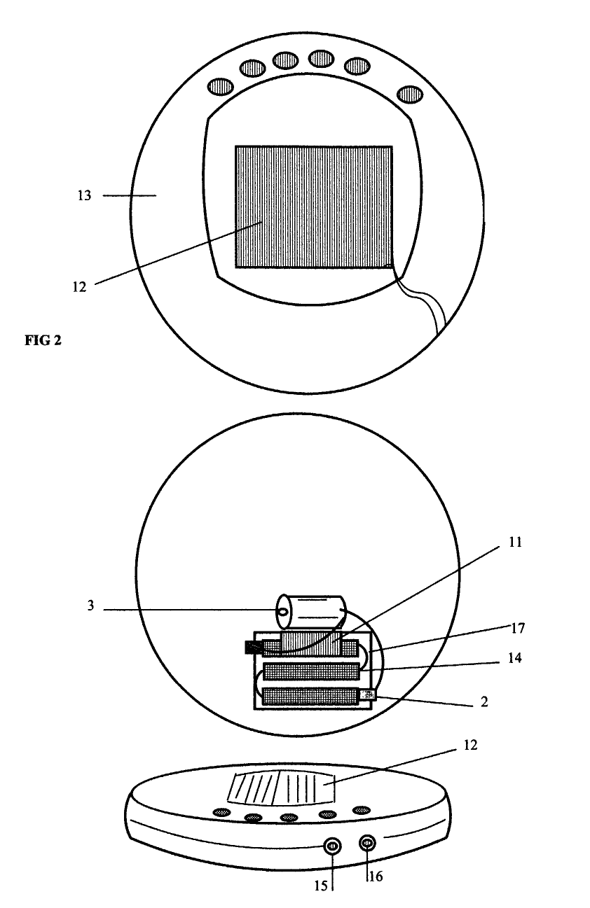

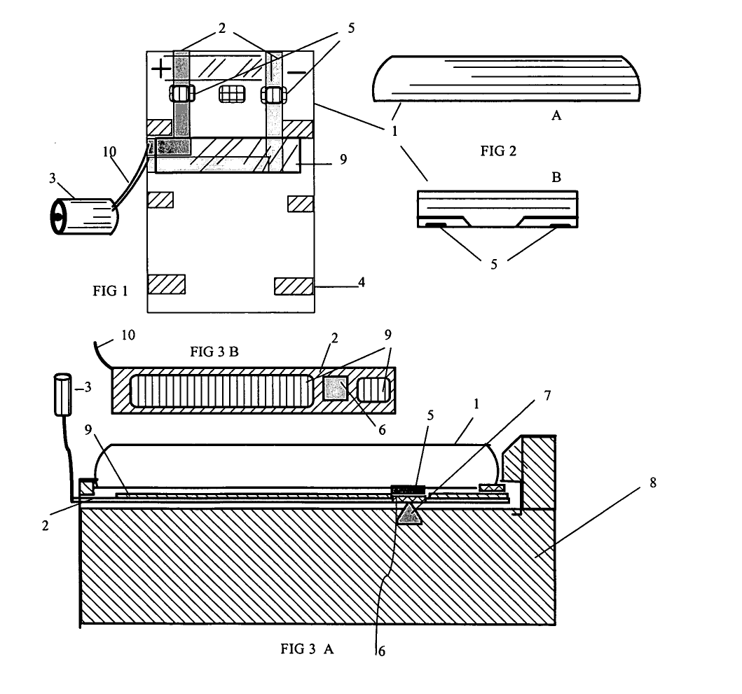

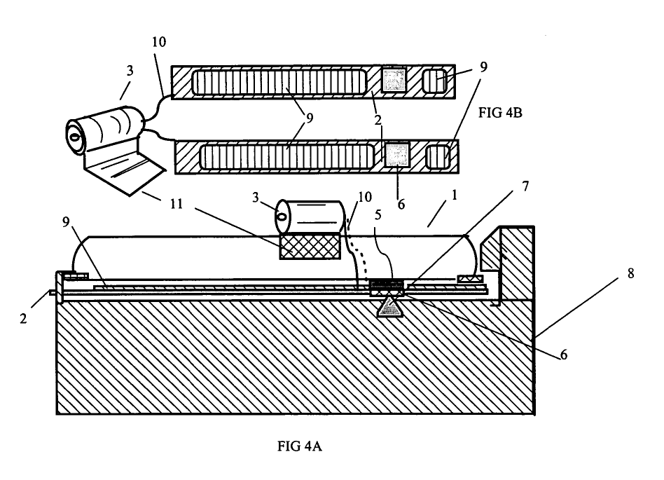

FIG. 1 shows the bottom FIG. 2 shows the side and end view of a flat rechargeable battery (1), of a camcorder or a cell phone where a flat, flexible conductor (2)is secured to the battery by means of two sided adhesive tape FIG. 3B (9) as it sandwiches between the rechargeable battery and the body of the camcorder or cell phone (8). Spring loaded electronic contact of the electronic apparatus (7) presses against a flat adapter cable and battery contact (5). Adapter cable (2) is terminated with the DC plug (3) using DC cable (10) to be connected to a solar cell or other type of external power source to allow the battery (1) to be charged by solar cell while battery is connected. FIG. 3 and FIG. 4 shows a flat battery (1) on the electronic apparatus (8) with the spring loaded connector (7) pressing against flat adapter cable (2) at un-insulated contact location (6) to form a firm plus and minus contact. DC connector (3) can be secured to the battery (1) with a piece of Velcro by flat plate (11).

What is claimed as my invention is the embodiments of a flat solar panel adapter in which an exclusive property or privilege is claimed are defined as follows:

1. a flat SOLAR PANEL ADAPTER (for Camcorders, portable CD players, radios, cell phones) compromises of: special flat adapter cable with a DC connector where the flat cable is sandwiched between a rechargeable battery and the spring loaded electronic contacts of the portable electronic device;
where the flat cable connects to a solar panel while the rechargeable battery is still attached to the electronic device (e.g. camcorder) extending the charge and usage time.

2. This is especially useful to extend battery life where no time or recharging is available (camping, walking, traveling (etc.);
where the flat cable is attached to the rechargeable battery with dual sided tape, at the battery connector the insulation is peeled away for positive three way contact.
